(19) United States
(12) Patent Application Publication
(10) Pub. No.: US 2005/0160686 A1
(43) Pub. Date: Jul. 28, 2005

(54) Interlocking conformable retainer wall system

(76) Inventor: Roger Williams, Schomberg (CA)

Correspondence Address: GOWLING LAFLEUR HENDERSON LLP, SUITE 1400, 700 2ND ST. SW, CALGARY, AB, T2P 4V5, CA

(21) Appl. No.: 10/765,935

(22) Filed: Jan. 29, 2004

(30) Foreign Application Priority Data
Jan. 28, 2004 (CA) 2,456,336

(51) Int. Cl. A01G 1/00; E02D 27/00; E04C 5/08

(52) U.S. Cl. 52/102; 47/33

(57) ABSTRACT

A retainer wall system comprised of interlocking wall segments for use as a retainer wall. Each wall segment is resiliently flexible to allow the retainer wall to follow a curvilinear/curved profile. In a preferred embodiment the wall segments comprise a plurality of substantially vertical elongate cylindrical members configured to resemble wooden logs, arranged in parallel in substantially mutually adjacent position. Each of the logs are coupled to an adjacent log by a resiliently flexible web member so as to permit flexible bending of each of each of the wall segments about a vertical axis therethrough. One or more of the logs making up each wall segment possess a longitudinal bore extending substantially along a vertical longitudinal axis of such log, so as to permit a pin member to be inserted therethough and into the ground so as to retain the wall segments in a desired conformed position.

### FIELD OF THE INVENTION

This invention relates to retainer walls, and in particular, to an interlocking retainer wall system which is flexibly conformable over its entire length to a desired contour.

### BACKGROUND OF THE INVENTION AND DESCRIPTION OF THE PRIOR ART

Retainer walls are frequently used in various landscape applications. For example, in recreational play areas and parks containing children's play equipment, such areas may be surrounded by a retainer wall to retain sand within such play area beneath the children's play equipment, and to define the play area. Similarly, retainer walls may also surround shrub and flower beds, to keep out small children and animals.

At least one type of retainer wall system is presently commercially available on the market for use as a retainer wall in children's play areas.

Specifically, in such commercially available retainer wall system, a number of interlocking wall elements are utilized, each of approximately 1.0 feet (0.33 m) in height, to form a continuous wall. Each of such wall elements comprises a relatively flat, elongate member, typically of a hard inflexible plastic material, which may be pinned at each of opposite ends thereof to an adjoining wall element so as to form a wall. The pin members which serve to pin mutually adjacent ends of wall elements together also pass through the respective wall element and thereafter into the ground, serving to anchor the wall elements to the ground. Each of the wall elements is typically 4 feet (1.3 m) in length, and longer wall elements, up to 10 feet (3.3 m) in length, may further have intermediate their length a plurality of pin members which pass therethrough to assist in anchoring such larger wall element to the ground and resist hoop forces tending to bow the elongate wall element.

Disadvantageously, however, the wall elements of the above prior art retainer wall system are not suitable for creating a retainer wall having a continuous curvilinear profile. Instead, should a curvilinear profile be desired to be used, a number of discrete linear segments must be used, each linear segment consisting of a single wall element. While shorter [around 4 feet(1.3 m) in length] wall elements may be used, the contour can only comprise a number of discrete linear elements due to the rigidity of the wall elements, and a continuous curvilinear contour for the retainer wall cannot be obtained, thus detracting in certain applications from the aesthetic appearance of such retainer wall. This is a serious limitation of such prior art design, since it limits the ability to utilize such wall system in high visibility urban areas such as parks and children's play areas, where aesthetics are important. Also, due to the requirement that the contour of the retainer wall be composed of discrete linear segments, employing such wall system for existing applications, such as surrounding an existing flower bed or children's play area having a pre-existing continuous curvilinear profile, is difficult.

Support devices have been used in masonry applications, as side edge support for planar brick surfaces such as patios, driveways, and sidewalks, during the curing of mortar used to set the bricks. These support devices typically consist of a plurality of disjoint resiliently flexible members, approximately 6 feet (2.1 m) in length, and approximately 4″ (10 cm) in height [ie the height of a typical masonry brick)]. In one embodiment known to the applicant such brick retainer elements are each deformable so as to permit them to be laid along a side edge of, for example, a brick sidewalk having a curvilinear profile. Steel peg members are driven through protruding “footpads” and into the ground, to ensure the retainer elements stays abutted the bricks. Notably, however, support devices as described above are non-interlocked and do not have any configuration to permit interlocking, nor are they of a configuration to provide any aesthetic appeal or serve any aesthetic purpose in addition to their purely functional role of a side edge support during curing of the brick mortar. In addition, due to their small height, such devices are not useful as a retainer wall in landscaping or park-like settings.

### SUMMARY OF THE INVENTION

In order to overcome certain of the disadvantages of the prior art, and in particular provide a retainer wall capable of providing a curvilinear profile, in a first broad embodiment of the present invention the present invention comprises a retainer wall system that is flexibly conformable and adapted to be affixed to the ground in a desired conformed position, comprising:

a plurality of wall segments, each having coupling means situate at opposed ends thereof to permit interlocked coupling of each wall segments together to form a retainer wall;

each of the said wall segments comprising a plurality of substantially vertical elongate members arranged side by each in parallel mutually adjacent position, each said vertical member having resiliently flexible web means flexibly coupling each said vertical member to an adjacent vertical member so as to permit flexible bending of each said wall segments about a vertical axis therethrough to said desired conformed position;

one or more of said plurality of vertical elongate members having longitudinal bore means extending substantially parallel to said vertical axis; and

elongate ground fixation means, such as an elongate metallic pin member, adapted to be inserted through said longitudinal bore and into the ground so as to retain said wall elements in said desired conformed position.

In another broad aspect of the present invention, the invention comprises a kit for creating a retainer wall, to allow assembly of a retainer wall that is flexibly conformable and which may be affixed to the ground in a desired contour. Such kit in one of its broad aspects comprises:

a plurality of wall segments, each having coupling means situate at opposed ends thereof to permit interlocked coupling of each wall segments together to form a retainer wall;

each of the said wall segments comprising a plurality of substantially vertical elongate members arranged side by each in parallel mutually adjacent position, each said vertical member having resiliently flexible web means flexibly coupling each said vertical member to an adjacent vertical member so as to permit flexible bending of each said wall segments about a vertical axis therethrough to said desired conformed position;

one or more of said plurality of vertical elongate members having longitudinal bore means extending substantially parallel to said vertical axis; and

elongate ground fixation means, adapted to be inserted through said longitudinal bore means and into the ground so as to retain said wall elements in said desired conformed position.

In still another aspect of the present invention, the present invention comprises a plurality of wall segments adapted to be positioned vertically and having coupling means to permit interlocked engagement of each wall segment to an adjoining wall segment;

each of the said wall segments comprising a plurality of substantially vertical elongate members arranged side by each in parallel mutually adjacent position, each said vertical member having resiliently flexible web means flexibly coupling each said vertical member to an adjacent vertical member so as to permit flexible bending of each said wall segments about a vertical axis therethrough to a desired conformed position;

one or more of said plurality of vertical elongate members of each wall segment having longitudinal bore means extending substantially parallel to said vertical axis; and

elongate ground fixation means, adapted to be inserted through said longitudinal bore means and into the ground so as to retain said wall segments in said desired conformed position.

In a preferred embodiment of each of the above embodiments of the invention the vertical members comprise elongate cylindrical members, having a wood grain impressed on the exterior of such cylindrical members to provide the appearance of wooden logs and thus provide a decorative effect and/or improve the aesthetic appearance of the wall segments. One or more logs in each wall segment possess a longitudinal bore, to permit insertion of a pin member which is of such a length so as to also be inserted into the ground so as to thereby retain the respective wall element in an desired conformed position.

In a preferred embodiment, to avoid susceptibility to rot or corrosion and to assist in forming the cylindrical members with an exterior wood grain exterior appearance, as well most importantly for the web member to be of a resiliently flexible nature and integrally formed with the cylindrical members (ie logs), each of the wall segments, web means, and vertical members are of a plastic material, such as a low or medium density polyethylene (LMDPE) or polypropylene. It has been found for web thicknesses in the range of about 3/16″ to 5/16″ (ie .0.47 cm to 0.79) that medium density polyethylene or propylene provide the necessary flexibility yet sufficient strength for the intended purpose of retainer walls, and allow the web members (and thus each of the wall segments sufficient bendability without undue force needed to be exerted for retainer wall heights in the range of 2½ to 3½ feet (ie 0.8 m to 1.2 m).

In the preferred embodiment, the elongate ground fixation means comprise a plurality of elongate pegs, typically of a corrosion resistant material and of considerable strength, such as steel or anodized/galvanized iron. As mentioned above, the pegs are inserted through a longitudinal bore located in one and preferably a number of the vertical members (ie logs, where cylindrical members having an simulated wood grain exterior are used) in each wall segment, and thereafter forceably driven into the ground. An upper portion of each pin member remains within in the wall element and a lower portion of which remains in the ground. Such pin members thereafter serve to retain each wall element in a desired conformed position, which may if desired by a curvilinear profile.

The coupling of individual wall elements to adjacent wall elements is preferably a means to permit interlocked pivotable coupling of the wall segments to each other. In a preferred embodiment this may be by means of a mortiss and tennon arrangement. In a preferred embodiment a pin may further be inserted along a longitudinal axis of the point of coupling to provide pivotable connection of each wall element to an adjacent wall element.

### BRIEF DESCRIPTION OF THE DRAWINGS

Further advantages and permutations will appear from the following detailed description of various non-limiting embodiments of the invention, taken together with the accompanying drawings, in which:

FIG. 1 is a perspective view of a prior art retainer wall system, having a plurality of interlocked (non-ornamental) solid panels;

FIG. 2 is a perspective view of prior art support elements, used to support curvilinear side edges of bricks during curing of mortar;

FIG. 3 is a perspective view of one embodiment of the interlocking, conformable retainer wall system of the present invention;

FIG. 4 is a sectional view of the retainer wall system shown in FIG. 3, taken along plane A-A;

FIG. 5 is a partial perspective view of an alternative embodiment of the retainer wall system of the present invention, showing an alternative means of interlocking the individual wall elements; and

FIG. 6 is a partial perspective view of yet another alternative embodiment of the retainer wall system of the present invention, showing yet another alternative means of interlocking the individual wall elements, namely via a mortises and tennon arrangment.

### DETAILED DESCRIPTION OF A PREFERRED EMBODIMENT

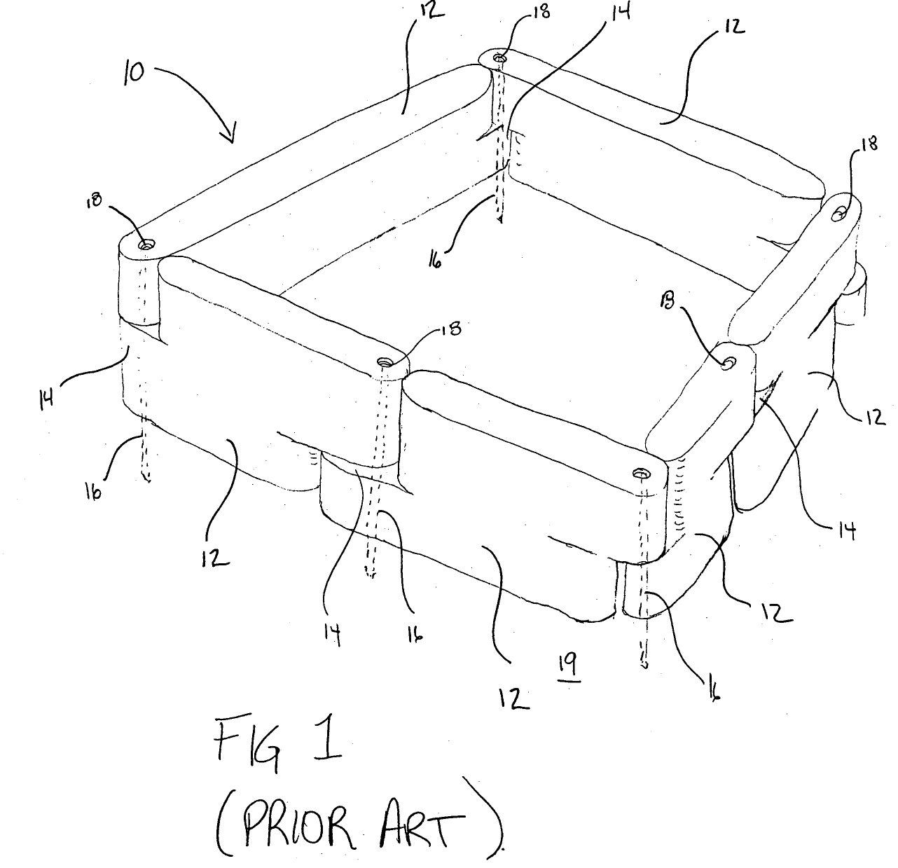

FIG. 1 shows a retainer wall system 10 of the prior art, having a plurality of interlocking wall elements comprising a relatively flat, elongate members 12 of a relatively inflexible plastic material. Each elongate member 12 possesses a protruding portion 14 which allows interlocked coupling to an adjacent elongate member 14 via a pin member 16. Pin member 16 passes through an aperture 18 in each elongate member 12 and thereafter into the ground 19, to retain the plurality of elongate members 12 in a fixed position to thereby serve as a retainer wall system 10.

Disadvantageously, elongate wall elements 12 of the prior art retainer wall system 10 are each of approximately 4 feet (1.3 m) in length, up to 10 feet (3.3 m) in length, and are not suitable for creating a retainer wall having a continuous curvilinear profile. Instead, should a curvilinear profile be attempted to be used, the closest approximation comprises a number of discrete linear segments comprised of a plurality of individual (linear) elongate members 12. This is unsatisfactory from an aesthetic point of view. Moreover, attempting to install such a retainer wall system 10 in an existing curvilinear profile, such as a curvilinear profile around a childrens play area or curvilinear profile around a flower bed, for example, results in a “poor fit”.

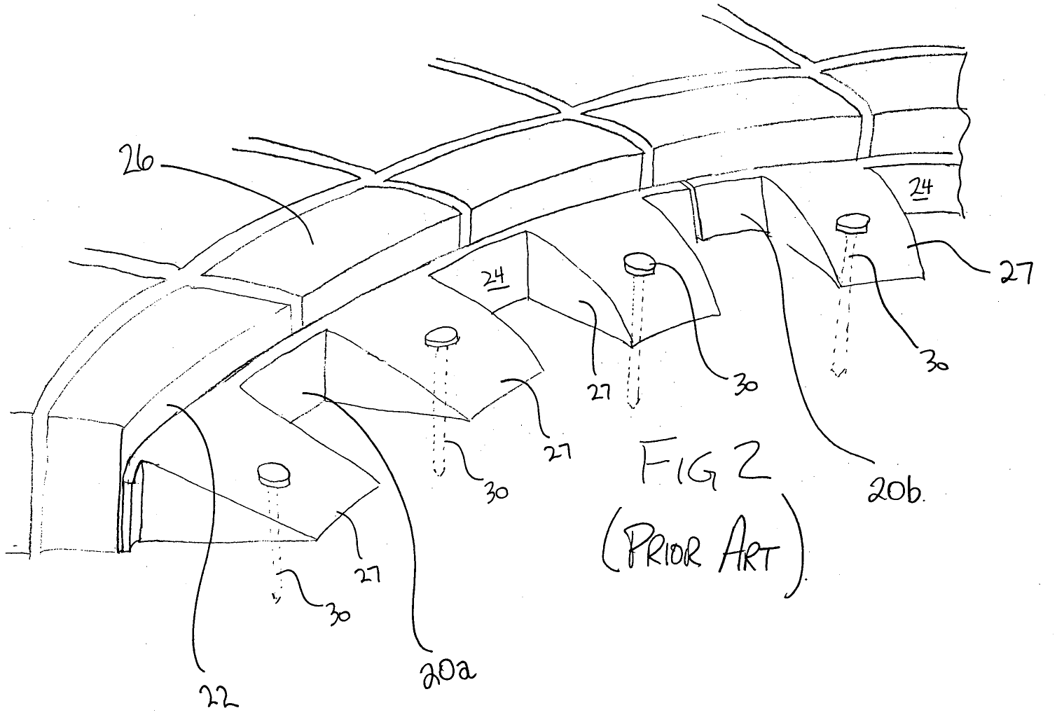

FIG. 2 shows a a pair of support devices 20a,b of the prior art used as a brick side edge 22 support for planar brick structures as sidewalks, driveways, and patios. Such prior art support device 20a,b consists of a plurality of individual resiliently flexible members 24, approximately 6 feet (2.1 m) in length, and approximately 4″ (10 cm) in height [ie the height of typical masonry brick]. In the embodiment shown in FIG. 2, the individual flexible members 24 are each bendable so as to permit them to be laid along a brick side edge 22 of a brick sidewalk 26 having a curvilinear profile. A plurality of protruding “footpads” 27 extend along one side 28 of each flexible member 24, so as to provide support. Steel peg members 30 are driven through such footpads 27 into the ground, to ensure flexible members 24 remain abutted against brick side edge 22 during the curing of the mortar for the brick sidewalk 26. Notably, however, flexible members 24 are not interlocked and do not have any configuration to permit interlocking, nor are they of a configuration to provide any aethetic appeal or serve any aesthetic purport in addition to their purely functional role of a side edge support for a brick side edge 22. In addition, due to their small height, such support devices 20a,b are not useful as a retainer wall.

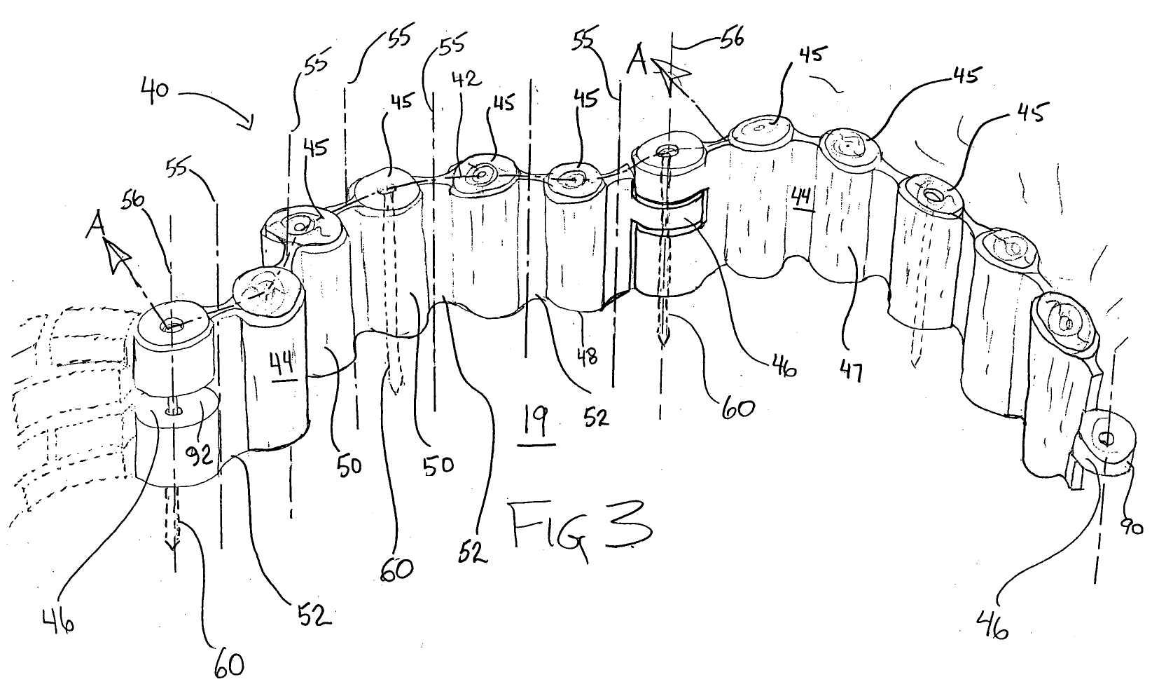

FIG. 3 shows a retainer wall system 40 of the present invention. Advantageoulsy, as may be seen from FIG. 3, such retainer wall system is flexibly conformable to a curvilinear profile 42, and may be affixed to the ground 19 so as to be retained in such curvilinear profile 42.

Retainer wall system 40 of the present invention comprises a plurality of wall segments 44, each having coupling means 46 situate at opposed ends 80a, 80b thereof to permit interlocked coupling of each wall segments 44 together to form a retainer wall 48, as shown in FIG. 3.

Each of wall segments 44 comprises a plurality of substantially vertical elongate members 50 arranged in parallel substantially mutually adjacent position. In a preferred embodiment, such vertical elongate members 50, have an aesthetic purpose, and in the embodiment shown in FIG. 3 are provided with a generally cylindrical profile resembling wooden logs 45. Wood grain exterior 47 may be embossed on the exterior surface of each log 45 to enhance the appearance of a wooden log 45.

Each vertical member 50 possess a resiliently flexible web member 52 which flexibly couples each vertical member 50 to an adjacent vertical member 50 so as to permit flexible bending of each of wall segments 44 about a vertical axis 55 therethrough to a desired conformed position.

One or more of vertical elongate members 50 possess a longtitudinal bore 56 substantially parallel to vertical axis 55. Ground fixation members, which in the preferred embodiment consist of metallic pin members 60 are adapted to be inserted through longitudinal bore 56 and driven forcefully into the ground 19 so as to retain wall segments 44 in a desired conformed position.

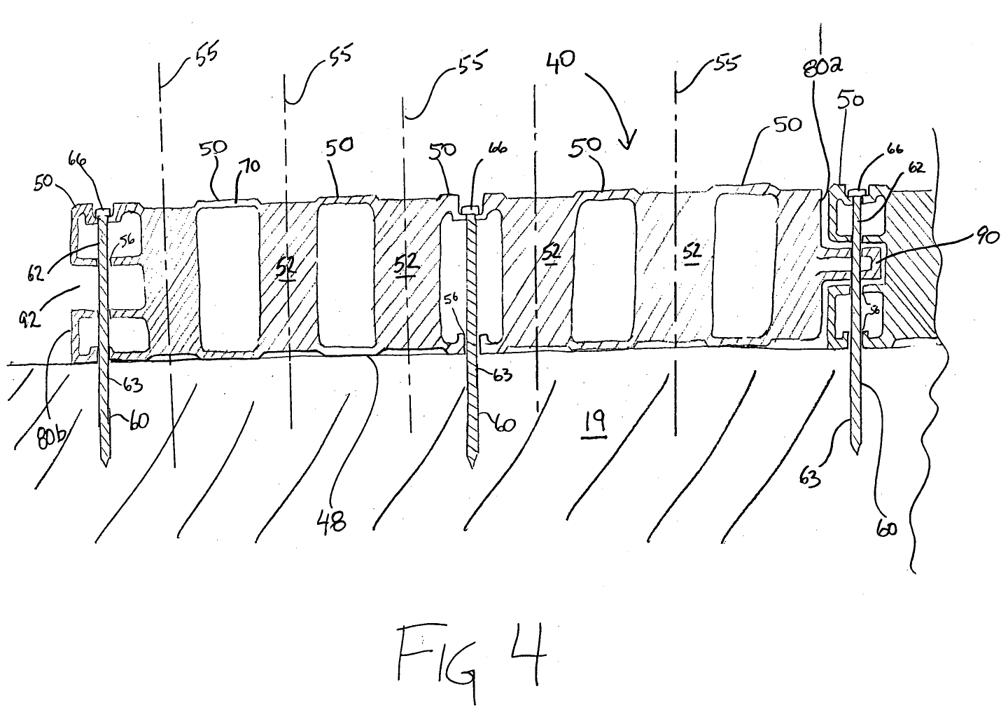

As may be seen from the cross-section of a wall system 40 of the present invention shown in FIG. 4, pin members 60 are of a sufficient length so that an upper portion 62 of each pin member 60 remains within the body of an individual vertical member 50, and a lower portion 63 of each pin member 60 may be forcefully driven into and extends into the ground 19. In a preferred embodiment, pin member 60 has a protruding cap member 66 which serves to ensure said wall member 44 remains affixed to the ground 19 by each pin member 60.

As may be seen from the cross-section of a preferred embodiment of the retainer wall 48 of the present invention shown in FIG. 4, each vertical member is preferably hollow and comprised of an exterior shell 70, in order to reduce weight and material. Each web member 52 may be solid but is preferably hollow to allow the plastic to better flow through the entire part during the moulding process and extends between each hollow vertical member 50.

In the preferred embodiment, each of the wall segments 44, web member 52, and vertical members 50 are of a plastic material, preferably medium density polypropylene or medium density polyethylene. It is found that such materials, for web members 52 of a thickness in the range of 3/16 (0.47 cm) to 5/16 (0.79 cm), are particularly suitable and permit the ability to manually bend a wall segment into a curvilinear profile. Such materials are also non-toxic, resistant to weather, are water impermeable (and thus do not decompose). These materials due to their thermo-plastic properties also permit roto-molding of each individual wall segment 44, which advantageously permits an aesthetic quality to be added to the wall segments 44 in that the individual vertical members 50 may be formed as imitation wooden logs 45 having a wood grain exterior imposed on the exterior surface 47. Other suitable materials will now readily occur to a person skilled in the art, including fibreglass, thermoformed carbon fiber composites, and the like.

In a first preferred embodiment, shown in FIGS. 3 & 4, the coupling means 46 present at opposed ends 80a,80b of each wall segment 44 comprises a mortises & tennon arrangement, comprising a protruding member 90 at one end 80a, and a mating slot 92 at opposite end 80b, to permit interlocking of an end 80a of a first wall element 44 to an end 80b of an adjacent wall element 44. In a preferred embodiment a pin member 60 may be inserted through a longitudinal bore 56 passing centrally through protruding member 90 and mating slot 92, to permit some rotation of one wall segment 44 relative to an adjacent interlocked wall segment 44, to assist in conforming a retainer wall 48 to a desired curvilinear profile.

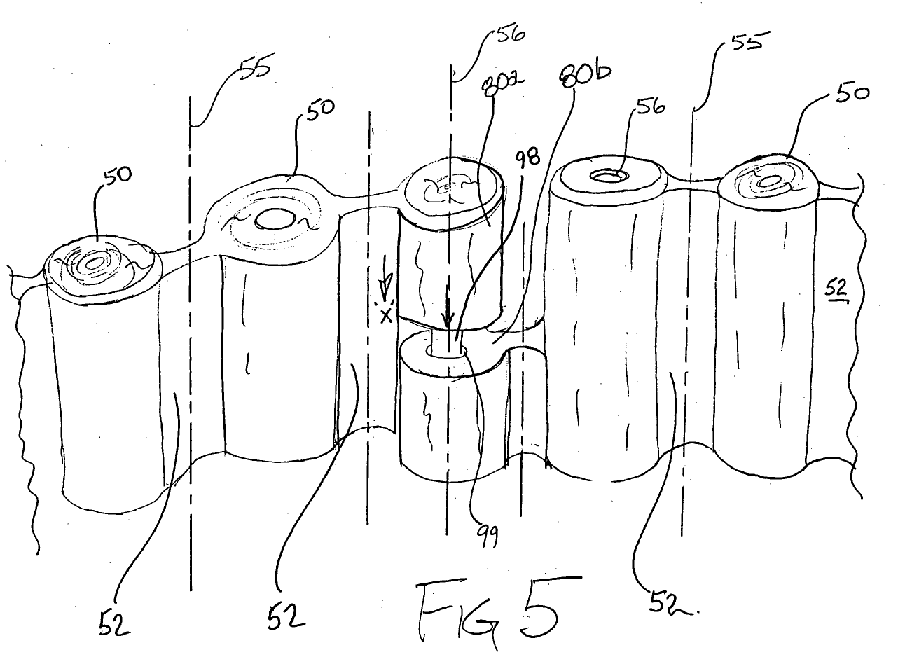

Other similar means of interlocking engagment of wall segments will readily become apparent to a person of skill in the art. By way of non-limiting examples, FIG. 5 shows an alternative manner of providing interlocking coupling of the wall segments 44. Specifically, the means 46 for coupling opposed ends 80a,80b of a first wall segment 44 to adjacent wall segments 44 may alternatively comprise a mating dowel arrangment, wherein a protruding dowel member 98 at a first end 80a of a wall segments is adapted for mating engagement with a mating aperture 99 at an opposite end 80b of a wall segment 44, by moving a first wall segment 44 in the direction shown by arrow “x” in FIG. 5 so as to allow dowel member 98 to matingly engage mating aperture 99. Advantageously such manner of interlocked coupling likewise provides for some rotation about longitudinal axis 57 to assist in positioning retainer wall 48 in a desired conformed position, particularly in a curvilinear profile.

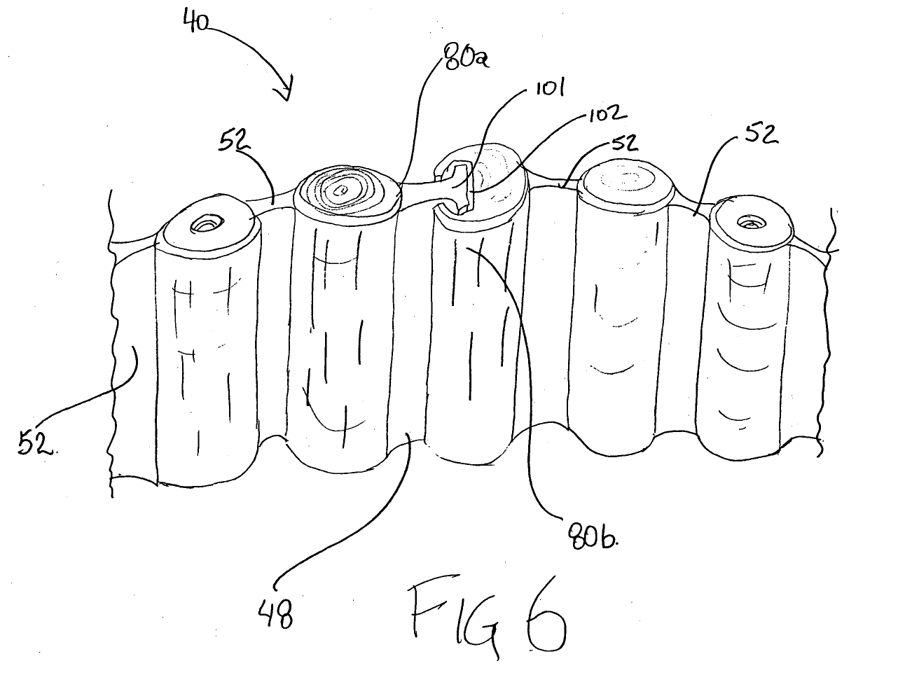

Likewise, another manner of accomplishing interlocking between adjacent pairs of wall segments is as shown in FIG. 6. A protruding spine member 101, in the shape of a “T”, extends from a first end 80a of a wall segment 44, and may be slidingly engaged with a corresponding aperture 102 in an opposite end 80b of an adjacent wall segment 44.

Alternate manners of providing interlocking between each of the wall segments 44 will now appear readily identifiable to persons of skill in the art. The manner of interlocking of wall segments 44 is not limited to the preferred embodiments disclosed herein.

Although the disclosure described and illustrates preferred embodiments of the invention, it is to be understood that the invention is not limited to these particular embodiments. Many variations and modifications will now occur to those skilled in the art. For definition of the invention, reference is to be made to the appended claims.

1. A retainer wall system that is flexibly conformable and adapted to be affixed to the ground in a desired conformed position, comprising:
a plurality of wall segments, each having coupling means situate at opposed ends thereof to permit interlocked coupling of each wall segments together to form a retainer wall;
each of the said wall segments comprising a plurality of substantially vertical elongate members arranged in parallel, substantially mutually adjacent position, each said vertical member having resiliently flexible web means flexibly coupling each said vertical member to an adjacent vertical member so as to permit flexible bending of each said wall segments about a vertical axis therethrough to said desired conformed position;
one or more of said plurality of vertical elongate members having longitudinal bore means extending substantially parallel to said vertical axis; and
elongate ground fixation means, adapted to be inserted through said longitudinal bore means and into the ground so as to retain said wall segments in said desired conformed position.

2. The retainer wall system as claimed in claim 1, wherein said vertical members comprise elongate cylindrical members, said longitudinal bore means comprising a longitudinal bore along a longitudinal axis of at least one of said cylindrical members.

3. The retainer wall system as claimed in 1, wherein said wall segments, web means, and vertical members are each of a plastic material selected from the group of plastic materials comprising medium density polypropylene or polyethylene.

4. The retainer wall system as claimed in claim 1, wherein said elongate ground fixation means comprises a plurality of elongate steel peg members adapters to be forcefully driven into the ground.

5. The retainer wall system as claimed in claim 1, wherein said coupling means comprises means to permit interlocked pivotable coupling of said wall segments to each other.

6. The retainer wall system as claimed in claim 1 wherein said vertical members comprise elongate substantially cylindrical members, each of a plastic material selected from the group of plastic materials comprising medium density polypropylene or polyethylene, and each of said substantially cylindrical members having an imitation wood grain thereon so as to give the appearance of wood.

7. The retainer wall system as claimed in claims 1, 5, or 6,
said coupling means having a longitudinal bore means which said ground fixation means may be inserted therethrough and into the ground to couple said opposed ends of said wall segments together and simultaneously affix them in said desired conformed position.

8. A kit for creating a retainer wall that is flexibly conformable and which may be affixed to the ground in a desired contour, comprising:
a plurality of wall segments, each having coupling means situate at opposed ends thereof to permit interlocked coupling of each wall segments together to form a retainer wall;
each of the said wall segments comprising a plurality of substantially vertical elongate members arranged side by each in parallel mutually adjacent position, each said vertical member having resiliently flexible web means flexibly coupling each said vertical member to an adjacent vertical member so as to permit flexible bending of each said wall segments about a vertical axis therethrough to said desired conformed position;
one or more of said plurality of vertical elongate members having longitudinal bore means extending substantially parallel to said vertical axis; and
elongate ground fixation means, adapted to be inserted through said longitudinal bore means and into the ground so as to retain said wall segments in said desired conformed position.

9. The kit as claimed in claim 8 wherein said vertical members comprise elongate cylindrical members, said longitudinal bore means comprising a longitudinal bore along a longitudinal axis of at least one of said cylindrical members.

10. The kit as claimed in 9, wherein said wall segments, web means, and vertical members are each of a plastic material selected from the group of plastic materials comprising medium density polypropylene or polyethylene.

11. The kit as claimed in claim 8, wherein said ground fixation means comprises one or more steel pegs members adapters to be forcefully driven into the ground.

12. The kit as claimed in claim 8, wherein said coupling means comprises means to permit interlocked pivotable coupling of said wall segments to each other.

13. The kit as claimed in claim 8, wherein said vertical members comprise elongate substantially cylindrical members, each of a plastic material selected from the group of plastic materials comprising medium density polypropylene or polyethylene, and each of said substantially cylindrical members having an imitation wood grain thereon so as to give the appearance of wood.

14. The retainer wall system as claimed in claims 8, 12 or 13, said coupling means having a longitudinal bore means through which said ground fixation means may be inserted therethrough and into the ground to couple said opposed ends of said wall segments together and simultaneously affix them in said desired conformed position.

15. A plurality of wall segments adapted to be positioned vertically and adjacent each other, having coupling means to permit interlocked engagement of each wall segment to an adjacent wall segment;
each of the said wall segments comprising a plurality of substantially vertical elongate members arranged side by each in parallel mutually adjacent position, each said vertical member having resiliently flexible web means flexibly coupling each said vertical member to an adjacent vertical member so as to permit flexible bending of each said wall segments about a vertical axis therethrough to a desired conformed position;
one or more of said plurality of vertical elongate members having longitudinal bore means extending substantially parallel to said vertical axis; and
elongate ground fixation means, adapted to be inserted through said longitudinal bore means and into the ground so as to retain said wall segments in said desired conformed position.

16. The plurality of wall segments as claimed in claim 15, wherein said vertical members comprise elongate cylindrical members, said longitudinal bore means comprising longitudinal bore along a longitudinal axis of at least one of said cylindrical members.

17. The plurality of wall segments as claim in claim 15 wherein said wall segments, web means, and vertical members are each of a plastic material selected from the group of plastic materials comprising medium density polypropylene or polyethylene.

18. The plurality of wall segments as claimed in claim 15, wherein said ground fixation means comprises one or more steel peg members adapted to be forcefully driven into the ground.

19. The plurality of wall segments as claimed in claim 15 wherein said coupling means comprises means to permit interlocked pivotable coupling of said wall segments to each other.

20. The plurality of wall segments as claimed in claims 15 or 19,
said coupling means having a longitudinal bore means through which said ground fixation means may be inserted therethrough and into the ground to couple said opposed ends of said wall segments together and simultaneously affix them in said desired conformed position.
